(19) United States
(12) Patent Application Publication
(10) Pub. No.: US 2024/0253152 A1
(43) Pub. Date: Aug. 1, 2024

(54) A DEVICE AND A METHOD FOR OPTICAL ENGRAVING OF A DIFFRACTION GRATING ON A WORKPIECE

(71) Applicant: BOEGLI-GRAVURES SA, Marin-Epagnier (CH)

(72) Inventors: Charles BOEGLI, Marin-Epagnier (CH); Gabriel DUMITRU, Nussbaumen (CH); Alain DROZ, Thielle (CH); Mario TONIN, Chaumont (CH)

(21) Appl. No.: 18/561,660

(22) PCT Filed: May 19, 2022
(86) PCT No.: PCT/IB2022/054660

§ 371 Date: Nov. 16, 2023

(30) Foreign Application Priority Data
May 19, 2021 (EP) 21174614.4

(51) Int. Cl. B23K 26/04; B23K 26/03; B23K 26/06; B23K 26/067; B23K 26/362; B42D 25/328; B42D 25/435

(52) U.S. Cl. CPC B23K 26/048; B23K 26/032; B23K 26/0648; B23K 26/067; B23K 26/362; B42D 25/328; B42D 25/435

(57) ABSTRACT

A device for engraving a diffraction grating on a workpiece, comprises an optical set-up comprising a laser, a beam forming device, a beam splitting device, and a focusing head. The laser is configured to output a laser beam. The beam forming device is configured to control a diameter of and a light intensity distribution in the laser beam, and output a primary laser beam. The beam splitting device is configured for a splitting of the primary laser beam into a plurality of split beams for the engraving. The focusing head comprises a microscope objective lens (109) configured to focus the respective split beams in respective foci on the workpiece, an auto-focusing system configured to produce a positioning signal for adjusting and maintaining a distance between the microscope objective lens and the workpiece in order to maintain the respective foci of the split beams on the workpiece and output the positioning signal; and a micro-actuator configured to receive the positioning signal and adjust the distance between the microscope objective lens and the workpiece, whereby the auto-focusing system and the micro-actuator are operationally connected in a closed-loop. The device for engraving further comprises a positioning device configured to perform a relative positioning between the workpiece in the respective foci of the split beams, and the optical set-up; and a controller configured to control the positioning device and the laser according to engraving instructions for the diffraction grating.

### TECHNICAL FIELD

The present invention relates to a device and a method for engraving a diffraction grating on a workpiece, more precisely engraving by means of a laser, the beam of which is split in a plurality of split beams.

### BACKGROUND ART

US publication US2009/0212030A1 concerns laser ablation at high pulse power with a working spot whose diameter is small and tightly controlled. It describes an invention which is an autofocus subsystem optimized to meet the particular constraints of high-precision ablation. It co-propagates the autofocus and working beams through most of the beam train to ensure that the autofocus will be affected by the same thermal changes as the working beam.

In this US publication, when the ablation process produces smooth-surfaced features, the most accurate autofocus reading may result when d=0, i.e., the autofocus focus on the workpiece and the working beam focus overlap. However, if the ablated surface is rough, the autofocus beam may be scattered, making its signal at the detector assembly too weak to read. In that case, d may be set >0, so that the foci do not overlap.

An object of the present invention is to realize a system for engraving a diffraction grating on a workpiece by means of a plurality of beams simultaneously. In order to reach this object, it is necessary to maintain the plurality of beams in focus on the surface of the workpiece, i.e., find a solution for the autofocus that can cope with a scattering nature of the diffraction grating being engraved or already present on the surface of the workpiece.

### SUMMARY OF THE INVENTION

In a first aspect, the invention provides a device for engraving a diffraction grating on a workpiece, comprising an optical set-up comprising a laser, a beam forming device, a beam splitting device, and a focusing head. The laser is configured to output a laser beam. The beam forming device is configured to control a diameter of and a light intensity distribution in the laser beam, and output a primary laser beam. The beam splitting device is configured for a splitting of the primary laser beam into a plurality of split beams for the engraving. The focusing head comprises a microscope objective lens (109) configured to focus the respective split beams in respective foci on the workpiece, an auto-focusing system configured to produce a positioning signal for adjusting and maintaining a distance between the microscope objective lens and the workpiece in order to maintain the respective foci of the split beams on the workpiece and output the positioning signal; and a micro-actuator configured to receive the positioning signal and adjust the distance between the microscope objective lens and the workpiece, whereby the auto-focusing system and the micro-actuator are operationally connected in a closed-loop. The device for engraving further comprises a positioning device configured to perform a relative positioning between the workpiece in the respective foci of the split beams, and the optical set-up; and a controller configured to control the positioning device and the laser according to engraving instructions for the diffraction grating. In a preferred embodiment, the device for engraving further comprises a power regulator comprising an optical modulator configured to adjust a power of the laser beam.

In a further preferred embodiment, the device for engraving further comprises an engraving power control device configured to selectively mask at least one of the plurality of split beams, thereby limiting a total beam power incident on the workpiece to that of non-masked split beams.

In a further preferred embodiment, the beam splitting device comprises a Spatial Light Modulator (SLM).

In a further preferred embodiment, the auto-focusing system comprises a probe light source emitting a probe light beam, the probe light source being configured as a low coherence light source and the probe light source being further configured to direct the probe light beam to the workpiece through the microscope objective lens; an interferometry set-up comprising a reference path and a measuring path, configured to receive as the measuring path the probe light beam after reflection on the workpiece, and the reference path being obtained by sending the probe light beam over a determined path comprising a reference lens configured to mimic the microscope objective lens and a mirror configured to mimic the workpiece, further whereby the reference path is of a given fixed predetermined length such that the difference between the reference path's given fixed predetermined length and a measurement path length is smaller than the spatial coherence length of the low coherence light source, further whereby the interferometry set-up is configured to combine a reference light beam exiting from the reference path and a measurement light beam exiting from the measurement path in order for these to interfere and output an interference spectrum; an optical spectrometer configured to read the interference spectrum output of the interferometry set-up and output an optical spectrum; a computing unit configured to input the optical spectrum from the optical spectrometer, analyze it and compute positioning data; a micro-actuator configured to move the microscope objective lens; and a digital/analog converter receiving the positioning data and outputting a driving signal to the micro-actuator in order to maintain the workpiece in the respective foci of the split beams.

In a further preferred embodiment, the auto-focusing system comprises a probe light source emitting a probe light beam, the probe light source being configured as a low coherence light source and the probe light being further configured to direct the probe light beam to the workpiece through the microscope objective lens; an interferometry set-up comprising a reference path and a measuring path, configured to receive as the measuring path the probe light beam after reflection on the workpiece, and the reference path being obtained by sending the probe light beam over a determined path comprising a reference lens configured to mimic the microscope objective lens and a mirror configured to mimic the workpiece, further whereby the reference path is of a given fixed predetermined length such that the difference between the reference path's given fixed predetermined length and a measurement path length is smaller than the spatial coherence length of the low coherence light source, further whereby the interferometry set-up is configured to combine a reference light beam exiting from the reference path and a measurement light beam exiting from the measurement path in order for these to interfere and output an interference spectrum; an optical spectrometer configured to read the interference spectrum output of the interferometry set-up and output an optical spectrum; a computing unit configured to input the optical spectrum from the optical spectrometer, analyze it and compute positioning data; a micro-actuator configured to move the positioning device; and a digital/analog converter receiving the positioning data and outputting a driving signal to the micro-actuator in order to maintain the workpiece in the respective foci of the split beams.

In a second aspect, the invention provides a method for engraving a diffraction grating on a workpiece, comprising providing a laser beam; forming the laser beam by controlling a diameter and a light intensity distribution in the laser beam, and output a primary laser beam; splitting the primary laser beam into a plurality of split beams for engraving; focusing the respective split beams on the workpiece with a microscope objective lens; auto-focusing the respective split beams by producing a positioning signal for adjusting and maintaining a distance between the microscope objective lens and the workpiece in order to maintain the respective foci of the split beams on the workpiece, outputting the positioning signal; receiving the positioning signal at the input of a micro-actuator and performing with the micro-actuator an adjustment of the distance between the microscope objective lens and the workpiece, whereby the autofocusing and the adjustment of the distance are performed in a closed-loop; performing a relative positioning between the workpiece in the respective foci of the split beams, and the optical setup by means of a positioning device, and controlling the positioning device and the laser according to engraving instructions for the diffraction grating and engraving the diffraction grating on the workpiece.

In a further preferred embodiment, the method for engraving further comprises a step of adjusting a power of the laser beam by means of a power regulator that comprises an optical modulator.

In a further preferred embodiment, the method for engraving further comprises a step of controlling an engraving power by selectively masking at least one of the plurality of split beams, thereby limiting a total beam power incident on the workpiece to that of non-masked split beams.

In a further preferred embodiment, the splitting of the primary laser beam into a plurality of split beams for engraving comprised employing a Spatial Light Modulator (SLM).

In a further preferred embodiment, the step of auto-focusing comprises emitting a probe light beam with a probe light source, the probe light source being configured as a low coherence light source, the emitting comprising a directing of the probe light beam to the workpiece through the microscope objective lens; implementing an interferometry set-up with a reference path and a measuring path, whereby the probe light beam is directed in the measuring path to pass through the microscope objective lens and to reflect on the workpiece, and the probe beam is further split and directed in the reference path by sending the probe light beam over a determined path that comprises a reference lens configured to mimic the microscope objective lens and a mirror configured to mimic the workpiece, further whereby the difference between the reference path length and a measurement path length is smaller than the spatial coherence length of the low coherence light source, further whereby the interferometry set-up is configured to combine a reference light beam exiting from the reference path and a measurement light beam exiting from the measurement path in order for these to interfere and output an interference spectrum; reading the interference spectrum output of the interferometry set-up by means of an optical spectrometer and outputting an optical spectrum; inputting the optical spectrum from the optical spectrometer in a computing unit and analyzing it and compute positioning data; moving the microscope objective lens by means of a micro-actuator; and receiving the positioning data in a digital/analog converter and outputting a driving signal to the micro-actuator in order to maintain the workpiece in the respective foci of the split beams.

In a further preferred embodiment, the step of auto-focusing comprises emitting a probe light beam with a probe light source, the probe light source being configured as a low coherence light source, the emitting comprising a directing of the probe light beam to the workpiece through the microscope objective lens; implementing an interferometry set-up with a reference path and a measuring path, whereby the probe light beam is directed in the measuring path to pass through the microscope objective lens and to reflect on the workpiece, and the probe beam is further split and directed in the reference path by sending the probe light beam over a determined path that comprises a reference lens configured to mimic the microscope objective lens and a mirror configured to mimic the workpiece, further whereby the difference between the reference path length and a measurement path length is smaller than the spatial coherence length of the low coherence light source, further whereby the interferometry set-up is configured to combine a reference light beam exiting from the reference path and a measurement light beam exiting from the measurement path in order for these to interfere and output an interference spectrum; reading the interference spectrum output of the interferometry set-up by means of an optical spectrometer and outputting an optical spectrum; inputting the optical spectrum from the optical spectrometer in a computing unit and analyzing it and compute positioning data; moving the positioning device by means of a micro-actuator; and receiving the positioning data in a digital/analog converter and outputting a driving signal to the micro-actuator in order to maintain the workpiece in the respective foci of the split beams.

### BRIEF DESCRIPTION OF THE FIGURES

The invention will be better understood through the detailed description of preferred example embodiments of the invention, and in reference to the appended drawings in which

FIG. 1 is a schematic overview of a device for optical engraving of a diffraction grating according to an example embodiment of the invention;

FIG. 2 is a schematic overview of a device for optical engraving of a diffraction grating according to a further example embodiment of the invention;

FIG. 3 contains a flowchart illustrating a method for engraving of a diffraction grating on a workpiece according to an example embodiment of the invention;

FIGS. 4A and 4B illustrate a prior art autofocusing system being used successfully in a case of a non-diffractive surface (4A) and how it can malfunction in case of a diffractive structure (4B);

FIG. 5 schematically illustrates a series of foci and an autofocus spot on a surface of a workpiece according to an example engraving using the invention:

FIGS. 6A, 6B and 6C schematically illustrate a first engraving scenario at 3 different instants, according to the invention;

FIGS. 7A, 7B and 7C schematically illustrate a second engraving scenario at 3 different instants, according to the invention;

FIG. 8 contains a photograph of engraved diffracted patterns resulting from the use of a prior art autofocusing system;

FIG. 9 contains a photograph of engraved diffracted patterns resulting from the present invention, according to an example embodiment;

FIG. 10 illustrates an autofocusing system based on Optical Coherence Tomography according to an example embodiment of the invention;

FIG. 11 is a schematic description of a focusing head with an autofocusing system according to an example embodiment of the device;

FIG. 12 illustrates schematically an engraving of a diffraction grating by means of split beams according to an example embodiment of the invention;

FIG. 13 is a schematic illustration of a beam forming device according to an example embodiment;

FIG. 14 contains a SLM beam splitting set-up;

FIG. 15 contains two example illustrations of beam splitting set-ups;

FIG. 16 contains a flowchart illustrating the algorithm for computing the phase of the SLM device according to an example embodiment;

FIGS. 17A and 17B show two illustrations of a beam and a reconstruction plane, the first (17A) showing a configuration in which the zeroth order contributes principally to an over-powering in the engraving, and the second (17B) shows a shifted position of a reconstruction plane, where the beams of first order contribute principally to the engraving;

FIG. 18 illustrates a use of a Fresnel phase in an SLM in order to shift a reconstruction plane in respect to the zeroth order of created split beams;

FIG. 19 illustrates a power control mechanism comprising a beam masking device according to an example embodiment;

FIG. 20 illustrates a positioning device for the workpiece according to an example embodiment of the invention;

FIG. 21 illustrates a focusing of a split beam on a work piece surface according to an example embodiment of the invention;

FIG. 22 illustrates an example for an embossing set-up that uses an embossing roller structured according to the invention;

FIG. 23 illustrates an example for an injection molding set-up that uses an injection molding insert structured according to the invention;

FIG. 24 depicts a third use case example in which gratings have been engraved with a device according to the invention, on a wristwatch case;

FIG. 25 illustrates a further use case example in which gratings embossed with an embossing tool that was obtained with an engraving according to the invention, have been transferred to a film of a blister packaging;

FIG. 26 illustrates a further use case example in which gratings have been transferred from an engraved embossing roller that was obtained with an engraving according to the invention, to a food packaging; and

FIG. 27 illustrates a further use case in which gratings have been transferred from an engraved embossing roller that was obtained with an engraving according to the invention, in a film bearing a pre-cured polymer coating.

Same references will be used throughout the figures to designates features and items that are the same or similar.

### DETAILED DESCRIPTION OF PREFERRED EMBODIMENTS OF THE INVENTION

The present invention relates to a device and a method for engraving a diffraction grating on a workpiece. The workpiece typically may comprise any one of metal, such as for example steel, ceramic or glass. A surface of the workpiece should comply with a certain standard of roughness in order for the diffraction grating to be able to appear as such and produce typical effects by diffracting incoming light. Hence the surface has a roughness standard better than N2. The workpiece may be for example of plan or cylindrical shape.

### Example Embodiments of a Device for Engraving

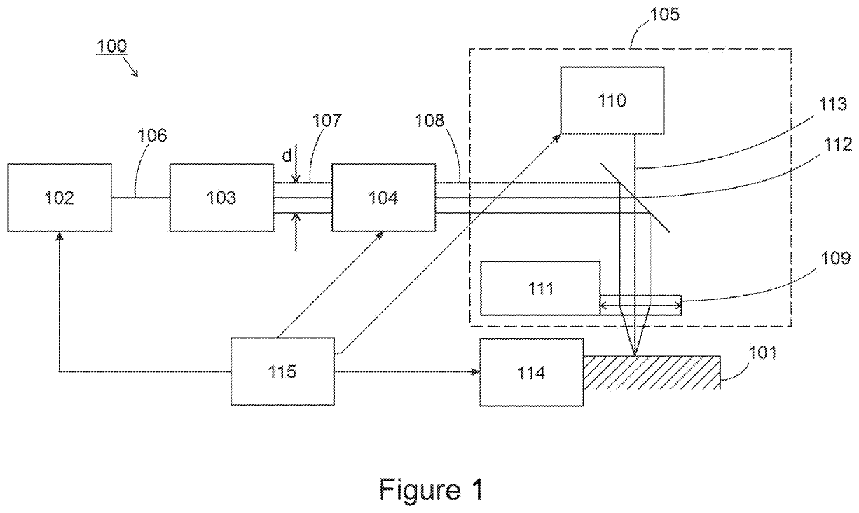

Referring to FIG. 1, this provides a schematic overview of an example embodiment of the device for engraving 100 of a diffraction grating (diffraction grating not illustrated) on a workpiece 101.

The device for engraving 100 comprises an optical set-up comprising a laser 102, a beam forming device 103, a beam splitting device 104 and a focusing head 105.

The laser 102 is configured to output a laser beam 106.

The beam forming device 103 is configured to control a diameter d of the laser beam and a light intensity distribution (not illustrated) in the laser beams, and outputs a primary laser beam 107.

The beam splitting device 104 is configured for a splitting of the primary laser beam 107 into a plurality of split beams 108 represented as one beam in FIG. 1 for an easier reading. The plurality of split beams 108 is for the engraving of the workpiece 101.

The focusing head 105 comprises a microscope objective lens 109 which is configured to focus the respective split beams in respective foci (respective split beams and respective foci not illustrated) on the workpiece 101. It further comprises an auto-focusing system 110 configured to produce a positioning signal for adjusting and maintaining a distance between the microscope objective lens 109 and the workpiece 101 in order to maintain the respective foci of the split beams on the workpiece 101, whereby the auto-focusing system 110 is further configured to output the positioning signal.

In a preferred embodiment the distance between the microscope objective lens 109 and the workpiece 101 may be adjusted according to the positioning signal by means of a micro-actuator 111. A beam splitter 112 may be configured to deviate the plurality of split beams 108 inside the focusing head 105 and allow a measuring beam 113 output from the auto-focusing system 110 to extend between the auto-focusing system 110 and the workpiece 101.

The device for engraving 100 of a diffraction grating further comprises a positioning device 114 configured to perform a relative positioning between the workpiece 101 in the respective foci of the split beams, and optical set-up, more particularly the focusing head 105.

A controller 115 is configured to control the positioning device 114 and the laser 102 according to engraving instructions (not illustrated) for the diffraction grating.

In a preferred embodiment, the control may further be configured to control the splitting device 104 and/or the auto-focusing system 110.

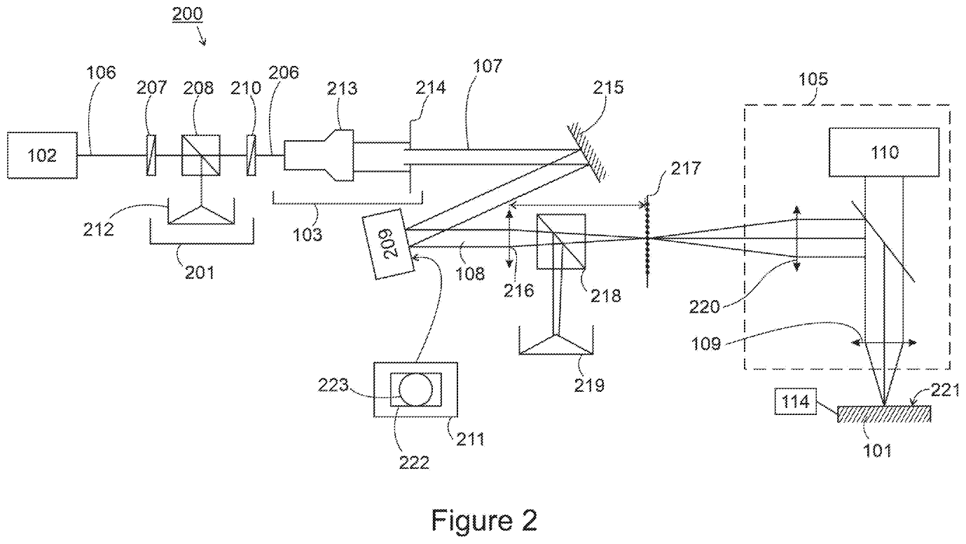

Referring now to FIG. 2, this contains a schematic overview of a device for optical engraving 200 of a diffraction grating according to a further example embodiment of the invention.

In FIG. 2, the controller 115 is left out, i.e., not illustrated, for a better readability, but it is however a feature of the device 200 and may be connected in a similar manner as explained in FIG. 1.

In the example of FIG. 2, the laser 102 may output a pulsed femtosecond laser beam 106 with a wavelength of 515 nm, a pulse duration less than 1000 fs, a frequency in the range of 50 to 200 kHz, an average power of less than 5 W, linearly polarized and with a Gaussian distribution of intensity.

A power regulator 201 is placed in the laser beam 106 to reduce a total power of the laser beam and output a laser beam 206. In that goal, the laser beam 106 passes through a first half wave plate 207 configured to rotate the polarization. A first polarizing beam splitter 208 then filters the laser beam, splitting a part of it to a beam dump 212. In a preferred embodiment the power of the laser beam 206 may be reduced and adjusted to less than 1 W. This approach is particularly useful when the laser is too powerful for components of the optical set-up, e.g., for a beam splitting device 209 which may be realized as a SLM (Spatial Light Modulator) head and could be damaged. A second half wave-plate 210 rotates the polarization of the laser beam so that it coincides with the optimized polarization of an SLM screen 211 of the SLM head 209.

The power adjusted laser beam 206 is then directed through the beam-forming device 103. This beam-forming device 103 preferably comprises a beam expander 213 that is configured to widen the size of the laser beam 206, e.g., for example with a magnification greater than 2×, to obtain the primary laser beam 107 which is an expanded beam. An iris 214 is inserted in the expanded beam to select a centre part of the expanded beam. The selected centre part of the expanded beam, which corresponds to the primary laser beam 107, can be approximated to a flat distribution because of the combination of the large Gaussian profile and the small iris. It is noted that this approach is considered to be better than the use of a beam-forming device such as a top hat shaper (not illustrated) because such a top hat shaper is very sensible to the orientation, positioning and size of the input beam, whereas the illustrated approach here is less prone to positioning errors. However alternative beam-forming devices may be considered to implement the present invention.

The primary laser beam 107 is directed over a reflector 215 to the centre of the SLM screen 211. The iris 214 of the beam-forming device 103 is set so that the size of the primary laser beam 107 matches a size of an active part of the SLM screen 211. On the SLM screen 211, we display a phase image inside an active area 222 of the SLM screen that is going to change the phase of the laser primary beam 107, falling on an area 223 which is within the active area 222 of the SLM screen. The SLM screen 211 may comprise an LCoS (Liquid Crystal on Silicon) display capable of shifting the incoming phase of light between 0 and 2pi. The phase to display may be calculated using a Gerchberg-Saxton algorithm to generate the plurality of split beams 108, i.e., an array of split beams separated by a given distance.

Back to the setup of FIG. 2, a reconstruction lens 216 after the SLM screen 211 is configured to focus individual phase shifted laser beams from the plurality of split beams 108 into a reconstruction plane 217 where the split beams first appear. In the reconstruction plane 217, the zeroth order of the reconstructed phase (not referenced in FIG. 2) may be an issue for the homogeneity of the plurality of split beams 108.

A second polarizing beam splitter 218 and second beam dump 219 is placed in the plurality of split beams 108 to filter a part of a laser beam that would have otherwise contributed to the zeroth order.

An optional Fresnel phase (not illustrated) may be added to the computed phase on the SLM screen 211 so that the reconstruction plane 217 of the split beams 108 does not coincide with the focal plane (not illustrated) of the reconstruction lens 216. In doing so, the reconstruction lens 216 focuses the zeroth order before or after the reconstruction plane 217 depending on the Fresnel phase that is used. The Fresnel lens parameters (its focal length) may be chosen so that the reconstruction plane 217 where the split beams 108 are reconstructed is shifted by a desired amount (e.g., greater than 10 mm) from the focal plane of the reconstruction lens 216. Because the zeroth order will be focused into the focal plane of the reconstruction lens 216, the zeroth order is no longer in focus at the same time as the split beams 108, the energy from the zeroth order is spreading over a large area in the reconstruction plane 217 and will not interfere with the split beams 108.

The focusing head 105, in the set-up of FIG. 2, comprises a tube lens 220 having for example a focal length of 200 mm. The tube lens 220 is configured to send an image from the reconstruction plane 217 to infinity, toward the microscope objective lens 109, which may be realized as an infinity corrected microscope objective. This infinity corrected microscope objective is required as it will be moved along its optical path for the autofocusing.

In a preferred embodiment. The microscope objective lens 109 may have a magnification greater than 20×, a Numeral Aperture greater than 0.35, a focal length smaller than 10 mm and a depth of field of smaller than 10 μm.

The microscope objective lens 109 creates the image of the reconstruction plane 217 with a reduction factor that is in direct relation to the magnification of the microscope objective lens 109 and the tube lens 220.

Because of the shallow depth of field of the microscope objective lens 109, it is necessary to carefully adjust the focus so that the image of the reconstruction plane 217 where the split beams 108 are located is coincident with a surface 221 of the workpiece 101.

The workpiece 101 may be moved to the focus position using the positioning device 114. This is done in a closed-loop manner. When the workpiece 101 is in position, the close adjustment of the focus may be performed using a micro-actuator (not illustrated in FIG. 2 for a better readability but known from FIG. 1 where it has the reference 111), for example a piezo electric drive that is moving the microscope objective lens 109 a few micrometres, until the perfect focusing position is reached. Alternatively, the micro-actuator may be applied to the positioning device 114. In a further alternative embodiment, each of the positioning device 114 and the microscope objective lens 109 may be adjusted for focusing using individual respective micro-actuators. Instead of the piezo electric drives, it would also be possible to use micro-adjustment motors or other appropriate types of micro-actuators.

A controller is sending inputs to the positioning device according to engraving instructions, to move the workpiece laterally in front of the microscope objective in order to engrave the grating. During this motion, the workpiece may drift away from the focusing position.

The controller (not illustrated in FIG. 2 but known from FIG. 1 where it carries the reference 115) is further configured to switch the laser 102 on and off depending on the needs for engraving expressed in the engraving instructions (also not illustrated).

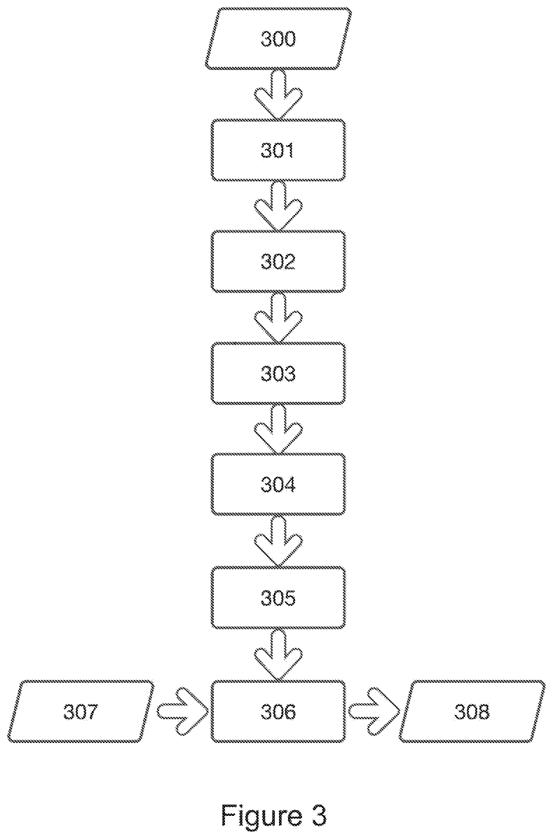

FIG. 3 contains a flowchart illustrating a method for engraving the diffraction grating on a workpiece according to an embodiment of the invention. The method comprises in step 300 providing a laser beam. In step 301 the laser beam is formed by controlling a diameter and a light intensity distribution in the laser beam and outputting a primary laser beam. In step 302 the primary laser beam is split into a plurality of split beams for engraving. In step 303 the respective split beams are focused on the workpiece with a microscope objective lens. In step 304 the respective split beams are auto-focused by producing a positioning signal for adjusting and maintaining a distance between the microscope and objective lens and the workpiece in order to maintain the respective foci of the split beams on the workpiece. The auto-focusing comprises outputting a positioning signal. In step 305 the positioning signal is received at the input of a micro-actuator and the micro-actuator performs an adjustment of the distance between the microscope objective lens and the workpiece, whereby the autofocusing and the adjustment of the distance are performed in a closed-loop manner. In step 306 a relative positioning is performed between the workpiece in the respective foci of the split beams, and the optical setup by means of a positioning device, and the positioning device and the laser are controlled according to engraving instructions 307 for the diffraction grating and the diffraction grating 308 is engraved.

The autofocusing system 110 tracks the surface 221 during the engraving to keep it in the depth of field of the microscope objective lens 109.

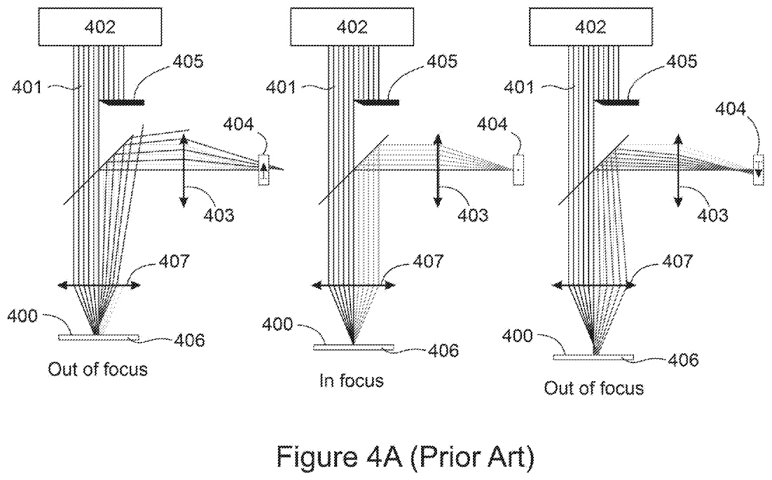

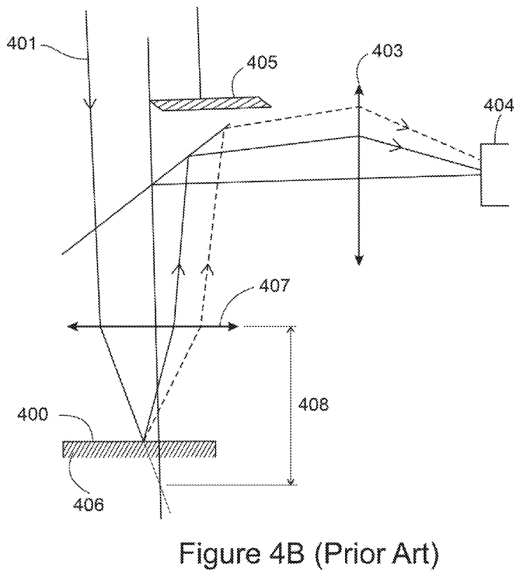

The applicant found that when using prior art autofocus systems, these showed that the engraving of diffractive structures was perturbing their autofocusing mechanism. In most comparatively “fast” commercial autofocusing systems, the autofocusing is done using the Foucault method, where a probe laser beam 401 is split in half by a knife-edge 405 as is illustrated in FIGS. 4A and 4B that contain schematic illustrations of the manner in which an autofocusing system using the Foucault method works. The surface to follow 400 reflects the probe laser beam 401 from laser 402 and a lens 403 images the probe laser beam 401 on a sensor 404. Depending on the position of the image of the probe laser beam 401, the autofocusing mechanism can detect a displacement of the workpiece 406. This is shown by examples in FIG. 4A, where on the position illustrated on the left side part of FIG. 4A and the position illustrated on the right-side part of FIG. 4A, the workpiece 406 is out of focus, and on the position in the middle part of FIG. 4A, the workpiece 406 is in focus. An autofocus computer (not illustrated in FIG. 4A and FIG. 4B) can then compute the displacement from the focus position using the centroid position (the position in the middle part of FIG. 4A). The autofocus computer then sends a correction signal to an actuator (not shown in FIG. 4A) to adjust the position of the workpiece 406, by either moving a microscope objective lens 407 or the workpiece 406, the microscope objective lens 407 having an objective focal length 408. Eventually, this kind of autofocus can follow the surface 400 if that surface 400 is in focus or not.

This method is sensitive to the reflection of the probe laser beam 401 and is not well adapted in the case in which the surface 400 is covered with diffractive structures, such as the ones we are engraving in the present invention. When the microscope objective lens 407 is out of focus, the structures on the surface 400 on the workpiece 406 are going to diffract the probing laser. This is going to change the angle of reflection of the probe laser beam 401 and the centroid of the reflection on the sensor 404 is not going to give the real position of the workpiece 406. Therefore, the correction signal sent to the actuator will be wrong and the objective lens 407 will not reach focus efficiently.

Several cases of autofocus scenarios can occur as will become apparent from the following explanation. Typically, the autofocus system can interfere directly with the gratings being engraved or the grating that were engraved in an earlier part of the engraving process.

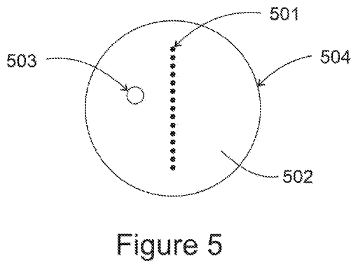

FIG. 5 schematically illustrates a series of foci 501 from focused split beams of a device for optical engraving of a diffraction grating (split beams and device not illustrated in FIG. 5) on a surface 502 of a workpiece and an autofocus spot 503 produced by the autofocusing system (not illustrated in FIG. 5) of the device. The autofocus spot 503 is projected on the surface 502 in proximity of the foci 501 inside a field 504 of the microscope objective lens (not illustrated in FIG. 5) of the device for optical engraving of a diffraction grating.

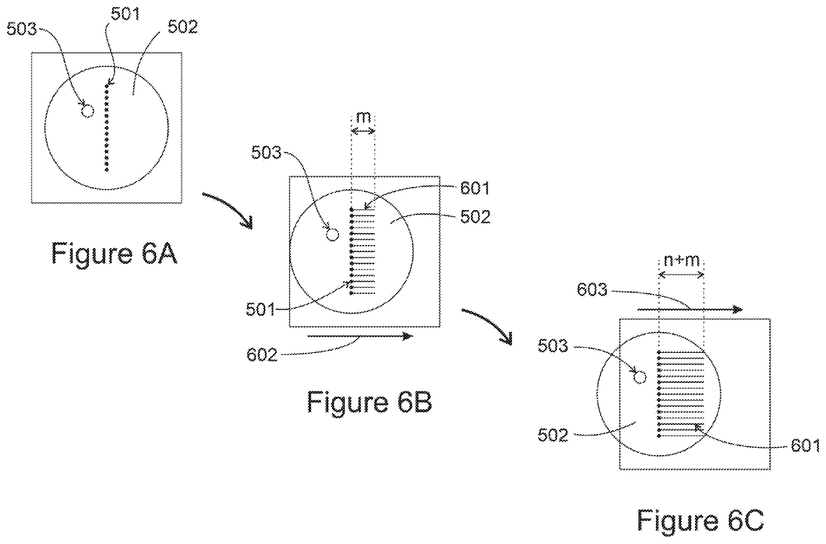

Referring now to FIGS. 6A, 6B and 6C, these illustrate a first engraving scenario where a motion of the workpiece during engraving is such that the focusing spot 503 is never directly over a grating 601 being engraved. FIG. 6A illustrates the initial position of the workpiece's surface 502 similar as in FIG. 5, whereas FIG. 6B shows the grating 601 having been engraved after the workpiece's surface 502 has been moved along direction 602 by a distance m, and FIG. 6C shows the grating 601 having been engraved after the workpiece's surface 502 has been moved along the direction 603 by a distance n+m. The autofocus spot 503 remains on the surface 502 and away from the grating 601 at all times.

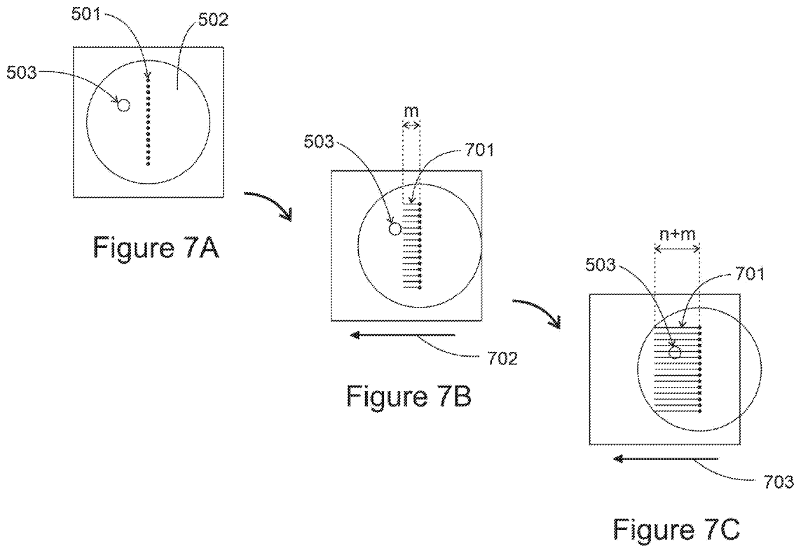

Referring now to FIGS. 7A, 7B and 7C, these illustrate a second engraving scenario where the motion of the workpiece's surface 502 is such that the focusing spot 503 may cross the grating 701 after the grating 701 has been engraved, and may cause the autofocus known from prior art to malfunction. FIG. 7A illustrates the initial position of the workpiece's surface 502 similar as in FIG. 5, whereas FIG. 7B shows the grating 701 having been engraved after the workpiece's surface 502 has been moved along direction 702 by a distance m and the focusing spot 503 is at the border of the grating 701 but not yet affected by the grating 701, and FIG. 7C shows the grating 701 having been engraved after the workpiece's surface 502 has been moved along the direction 703 by a distance n+m and the focusing sport 503 is reflected on the grating 701. Hence in FIG. 7C the grating 701 may cause the autofocus known from prior art to malfunction because the reflected focusing spot 503 becomes too diffuse.

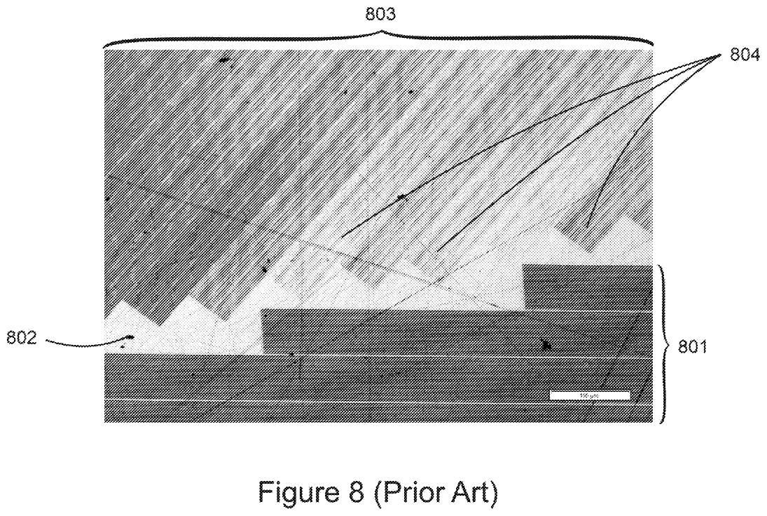

Referring now to FIG. 8, this illustrates a third engraving scenario in which the autofocus spot implemented according to prior art autofocusing system's technology (not illustrated in FIG. 8) may cross the path of a first diffractive structure 801 already present on a surface 802 of the workpiece, which can cause the autofocus to malfunction (autofocus not illustrated in FIG. 8). FIG. 8 illustrates by means of a photograph, various engravings of the surface 802 including the first diffractive structure 801 and a second diffractive structure 803, each diffractive structure comprising a set of linear structures substantially parallel among each other. The linear structures of the first diffractive structure 801 have been engraved first on the initially smooth surface of surface 803, and during this engraving which was made according to the scenario of FIGS. 6A to 6B, the autofocus was not perturbed. Hence the lines of the diffractive structure 801 all have a comparatively equal appearance in the photograph. For the engraving of the linear structures of the diffractive structure 803, a same scenario as in FIGS. 6A to 6B was applied, and the autofocus had to be swept above the vertical linear structures of the first diffractive structure 801, which perturbed the position reading and lead to the out of focus parts of the linear structures of the second diffractive structure 803, represented by lighter parts 804 of the linear structures.

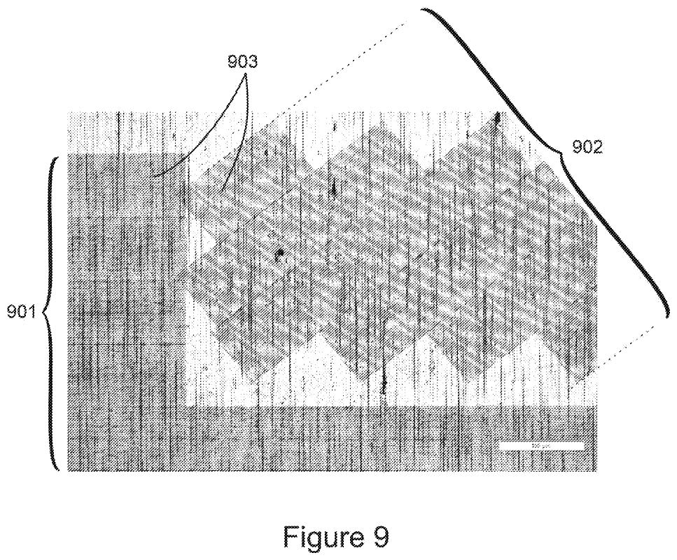

The applicant of the present patent application implemented a novel type of autofocusing system that is insensitive to such diffractive patterns on the surface of the workpiece. In contrast to the results illustrated in FIG. 8, the engraving of diffraction gratings on a workpiece with a plurality of split beams and the novel type of autofocusing system enables to obtain an even quality of the linear structures as illustrated in FIG. 9 by means of a photograph, which illustrates diffractive structures 901 and 902 in which the respective linear structures all have the same quality, as indicated by the constant filling 903 used to illustrate the linear structures.

The solution involved the developing of an autofocus system 110 based on the principle of Optical low-Coherence Interferometry/Tomography (OCT).

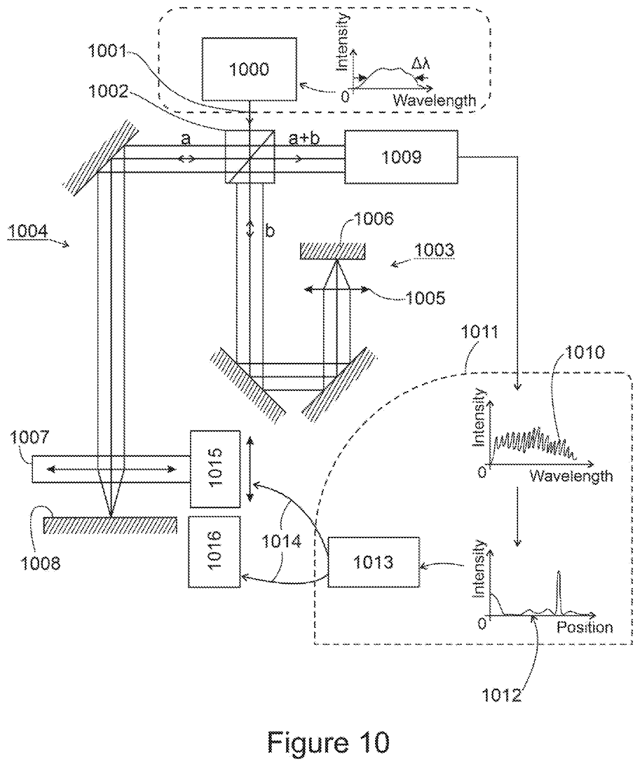

Referring to FIG. 10, this schematically illustrates an example embodiment of the autofocusing system according to the invention. The autofocusing system uses a low coherence light source 1000 to emit a probe light beam 1001. The low coherence refers to a spectral bandwidth of several nm. The probe light beam 1001 goes through an interferometric setup. A beam splitter 1002 divides the probe light beam 1001 into two parts a and b. The part a of the probe light beam 1001 goes in a second arm of the interferometer that is a measurement path 1004. The part b of the probe light beam 1001 goes in one arm of the interferometer that is a reference path 1003. The difference between a reference path's length 1003 and a measurement path's length 1004 is smaller than the coherence length of the low coherence light source 1000 close to the length of the measurement path 1004. At the end of the reference path 1003 is a lens 1005 and a mirror 1006 that are mimicking a microscope objective 1007 and a workpiece surface 1008. On the measurement path 1004, the probe light beam a goes through the microscope objective 1007 and reflects on the workpiece surface 1008. The probe light beam a from the measurement path 1004 and the probe light beam b from the reference path 1003 are then combining a+b through the beam-splitter 1002 and interfere. An optical spectrometer 1009 then captures the interference spectrum between the two probe light beams a+b and sends a recorded spectrum 1010 to a computer 1011 where an algorithm performs a Fourier transform on the recorded spectrum, obtains from the Fourier transform a series of peaks corresponding to reflections on each surface in the optical path, and filtering the peaks to isolate the peak corresponding to the reflection on the workpiece, and to determine from the latter peak a relative position 1012 of the workpiece surface from the microscope objective 1007. The positioning data 1013 is computed from the relative position 1012 and a predefined reference position of the workpiece surface 1008. The determining of the relative position of the workpiece surface from the microscope and the computing from the relative position and a predefined reference position of the positioning data is done according to methods and computing technique well known in the area of Optical Coherence Tomography and will not be detailed anymore in the present description.

From that positioning data 1013, and from the desired position of the workpiece 1008, the computer 1011 then gives a correction signal, i.e., a driving signal 1014 to a microactuator 1015, e.g., a piezo-electric actuator that moves the microscope objective lens 1007 so that the surface 1008 of the workpiece stays in focus of the microscope objective lens 1007. Alternatively, or in addition, the driving signal may also be directed to a positioning system 1016 to move the surface 1008 of the workpiece to stay in focus of the microscope objective lens 1007.

The autofocusing system and the micro-actuator are operationally connected in a closed-loop in order for continuously monitoring and adjusting the distance between the workpiece and the microscope objective lens.

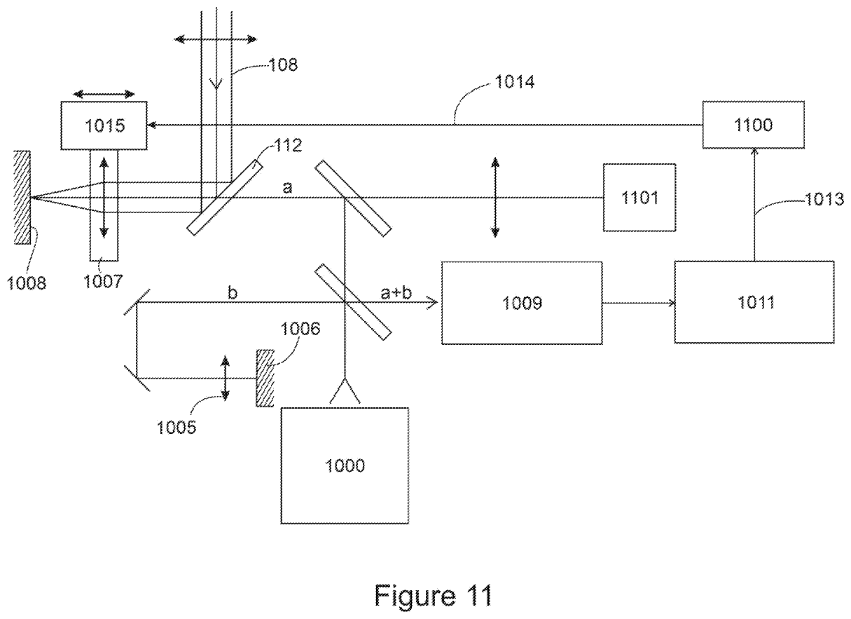

As shown in FIG. 11, which contains a schematic description of a focusing head with an autofocusing system according to the invention, the computer 1011 may comprise a digital/analogue converter 1100 that is configured to receive the positioning data 1013 and output this as the driving signal 1014. In FIG. 11, the plurality of split beam 108 is also coupled through the microscope objective lens 1007 by means of the beam splitter 112. An optional CCD camera 1101 is configured to receive light reflected from the surface 1008 for live observation of the surface 1009

The autofocus needs to work at comparatively high speed to follow the motion of the workpiece. The autofocus may for example work at sampling rates above 10 Hz, so that the position is following closely the surface at all times, i.e., in the closed-loop. The axes of the positioning system 1016 may for example move at a speed of 1 mm/s, which means that the autofocus checks and adjusts the position of the focus at the most every 100 microns of displacement of the axes.

The reflection of the probe light beam a on the workpiece 1008 surface may be comparatively strong and therefore may overshadow reflexions from the internal optics of the microscope objective and the other optical elements in the path. A simple data filtering may resolve the actual position of the workpiece surface 1008.

Because the OCT type autofocus does not rely on the way the light is reflected on the surface, it is not sensitive to the diffractive structures and can be used efficiently in the case where the surface to follow is being engraved with the diffractive structures. In addition, the OCT type autofocus is also efficient when engraving a surface that already carries a diffracting structure, i.e., when the diffracting structure being engraved is being superposed on an existing diffracting structure.

### Laser Source

The laser source that provides the energy for engraving may be chosen from a wide variety of laser sources.

It may be necessary to limit the laser power and pulse duration because of the heating of the SLM head. Hence these parameters need to be carefully adjusted. The SLM LCoS head is very sensitive to changes of temperature and should preferably be cooled. Also, incident light with a power that exceed the power threshold of the SLM head can permanently damage it.

Practically, in commonly available SLM devices, if the peak power density on the SLM is above 20 MW/cm², there is a damage risk on the LCoS. For a CW laser, the damage threshold is an average density power of 60 W/cm² with a cooled SLM head.

For precise laser ablation, a preferred embodiment is to work with a femtosecond laser. However, a picosecond laser may also work in this application. Even larger pulse durations may work, but the result would possibly be degraded by the thermal effect on the surface we are engraving.

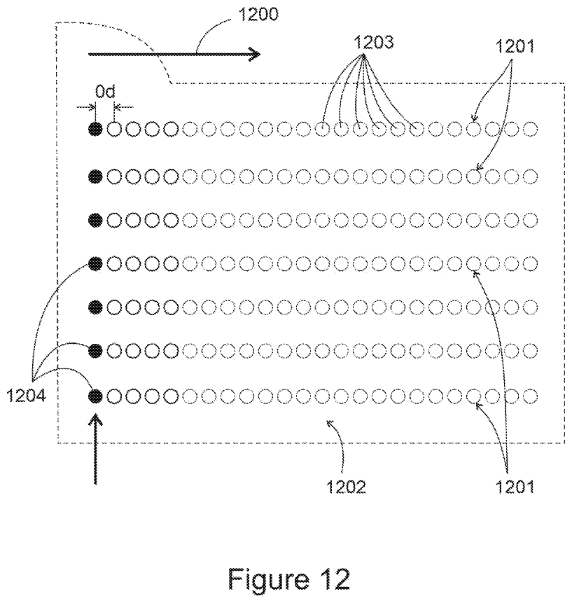

Referring to FIG. 12, this illustrates schematically an engraving of a diffraction grating by means of split beams according to an example embodiment of the invention. A plurality of laser impact spots from a plurality of split beams (split beams not illustrated) have been produced in lines 1201 on a surface 1202 of a workpiece. Preferably, the laser frequency is chosen to be between 1 kHz and 10 MHz (laser not illustrated in FIG. 12). The frequency of the laser depends on the speed at which the surface of the workpiece is moving, the movement being indicated by an arrow 1200 and the desired distance between two successive laser impulses as indicated by the distance Od between two successive laser impact spots on the surface 1202. Repeated aligned impacts 1203 illustrated with white circles, of the split beam distribution (which is illustrated by black circles 1204) create a grating structure. Typically, if the laser frequency is higher, we may obtain the same distance Od between successive laser impact spots by moving the surface of the workpiece at a faster speed.

The wavelength of the laser is preferably chosen to be 515 nm. It may however be of any value as appropriate.

The polarization state of the laser is preferably linear because the LCoS screen is sensitive to polarization and works only on horizontally polarized light. If the laser light is not polarized, one could add a polarizing step, which is relatively straightforward.

### Microscope Objective Lens

The microscope objective lens may be any type of microscope objective lens used for laser engraving.

For the engraving of optical gratings, we need to have a small focusing spot, at most half of the desired period. If we want to engrave gratings with a period of 1 μm, this means that the maximum focusing spot diameter for the split beams is 500 nm.

From this information, one can find the required relationship between the objective's numerical aperture and the laser wavelength according to the formula:

$$( focusing spot diameter ) \approx 2 / pi * wavelength / ( numerical aperture )$$

We can therefore understand that for better results, the wavelength must be small and the numerical aperture large.

For a “blue/UV” wavelength of 343 nm for instance, the numerical aperture of the objective must be at least 0.44 to have a focusing spot diameter of 500 nm.

For a “green” wavelength of 515 nm, the objective numerical aperture must be at least 0.66.

For an “infrared” wavelength of 1030 nm, the objective numerical aperture must be at least 1.3, which is not possible without an immersion objective, which is not an option for the present application.

Additionally, the minimum distance between two split beams is of considerations as well. If a SLM is used, this minimum distance depends on the SLM screen resolution and the focal length of the reconstruction lens by the formula:

$$( minimal reconstruction separation ) = 2 * ( reconstruction lens focal ) * wavelength / ( SLM pixel width ) / ( width of the SLM in pixels )$$

Increasing the number of pixels on the SLM (and therefore increasing the size of the beam), as well as reducing the wavelength and the focal length of the reconstruction lens can help in reducing the minimal reconstruction separation. This approach is limiting as spherical aberration will become predominant when decreasing the wavelength and decreasing the focal length of the reconstruction lens. A better approach is to use the fact that the microscope objective lens will have a given magnification and act as a reducer to project the image of the reconstruction plane on the surface of the workpiece.

In case a different beam splitter is used than a SLM, we have different analogue parameters, the adjusting of which is well known to the person skilled in the art and will not be discussed here in greater detail.

### Beam Forming Device

The power adjusted laser beam 206 is then directed through the beam-forming device 103. This beam-forming device 103 preferably comprises a beam expander 213 that is configured to widen the size of the laser beam 206, e.g., for example with a magnification greater than 3×, to obtain the primary laser beam 107 which is an expanded beam. An iris 214 is inserted in the expanded beam to select a centre part of the expanded beam. The selected centre part of the expanded beam, which corresponds to the primary laser beam 107, can be approximated to a flat distribution because of the combination of the large Gaussian profile and the small iris combination.

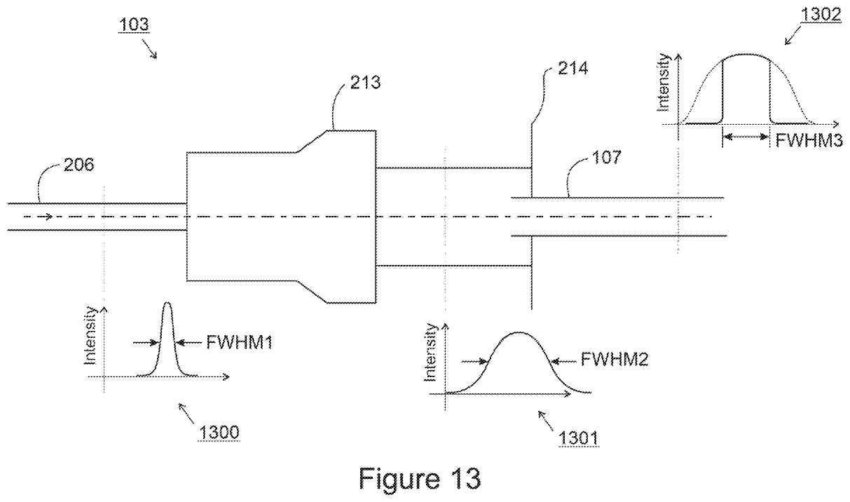

Referring to FIG. 13, this shows a schematic illustration of a beam forming device according to an example embodiment of the invention. It is similar to that shown in the set-up of FIG. 2, in that it shows the power adjusted laser beam 206 being directed through the beam-forming device 103. The beam-forming device 103 comprises the beam expander 213 that is configured to widen the size of the laser beam 206 to obtain the primary laser beam 107 which is an expanded beam. The iris 214 is inserted in the expanded beam to select the centre part of the expanded beam. The selected centre part of the expanded beam, which corresponds to the primary laser beam 107, can be approximated to a flat distribution because of the combination of the large Gaussian profile and the small iris combination.

The beam forming device 103 could comprise any element that is configured to shape the power adjusted laser beam 206 with a first gaussian intensity distribution having a full width at half maximum FWHM1 as illustrated in graph 1300 first into a second wider gaussian intensity distribution having a full width at half maximum FWHM2>FWHM1 as illustrated in graph 1301 into the primary laser beam 107 that has a top hat intensity distribution having a full width at half maximum FWHM3 as illustrated in graph 1302.

Such element may for instance comprise holographic plates that can create any sort of arbitrary beam distribution.

One might also use a series of optical elements that have a shape designed to morph the gaussian distribution into a top hat (such as a refractive beam forming device).

Preferably, the invention makes use of a specific beam shape and diameter of the primary laser beam 107 for which the holographic element or the optical elements are specifically created. Additionally, they require a very fine alignment to achieve the desired result.

### Beam Splitting Device

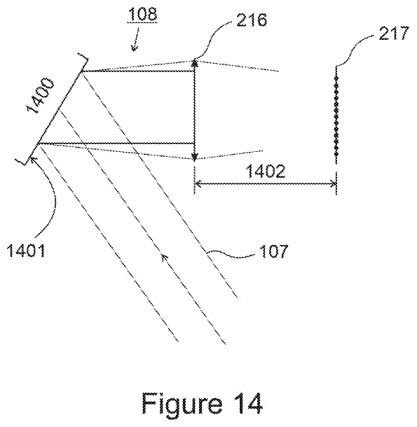

The present invention preferably makes use of a SLM (Spatial Light Modulator) for creating the split beam. One example SLM beam splitting set-up is illustrates schematically in FIG. 14 in which the primary laser beam 107 reaches and reflects on a Liquid Crystal on Silicon (LCoS) display 1401 of a SLM 1400 to obtain the plurality of split beams 108. The latter are then directed through the reconstructions lens 216 to be focused as corresponding multiple points in the reconstruction plane 217, which is distant from the reconstruction lens 216 by a reconstruction length 1402.

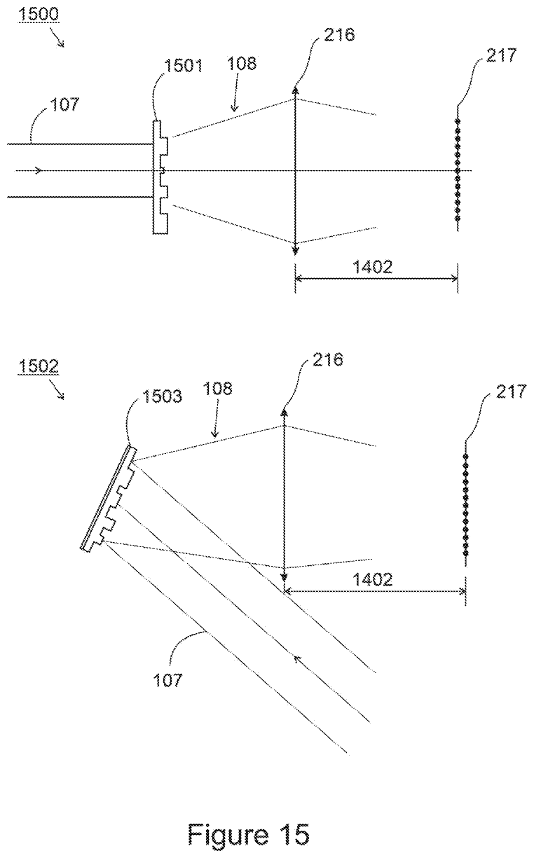

Referring to FIG. 15, in further embodiments, the invention may make use of different beam splitting devices such as for example a set-up 1500 with a holographic plate in transmission 1501 or a set-up 1502 with a holographic plate in reflexion 1503 that respectively will split the incoming primary laser beam 107 into any desired configuration of split beams 108.

Another example not illustrated may be a set-up in which the holographic plate is fixed on a rotating mount to rotate the split beam distribution. The holographic plate may be used with or without a focusing lens to create the distribution of split beams.

A further example not illustrated may involve the use of a grating (in transmission or in reflexion) such as a Dammann grating in place of the SLM to generate a distribution of split beams after being focused by a lens. This is similar to the set-up with the holographic plate.

A further example not illustrated may involve the use of a SLM where the phase is changing constantly and in which case, there is the possibility to change on the fly the number of split beams, while doing the engraving. It is then also possible to change some parameters of the split beams on the fly, such as the distance between the split beams or their distribution in the reconstruction plane.

### Spatial Light Modulator (SLM)

The Spatial Light Modulator is, by definition, a device that modifies the phase of a laser beam that it interacts with.

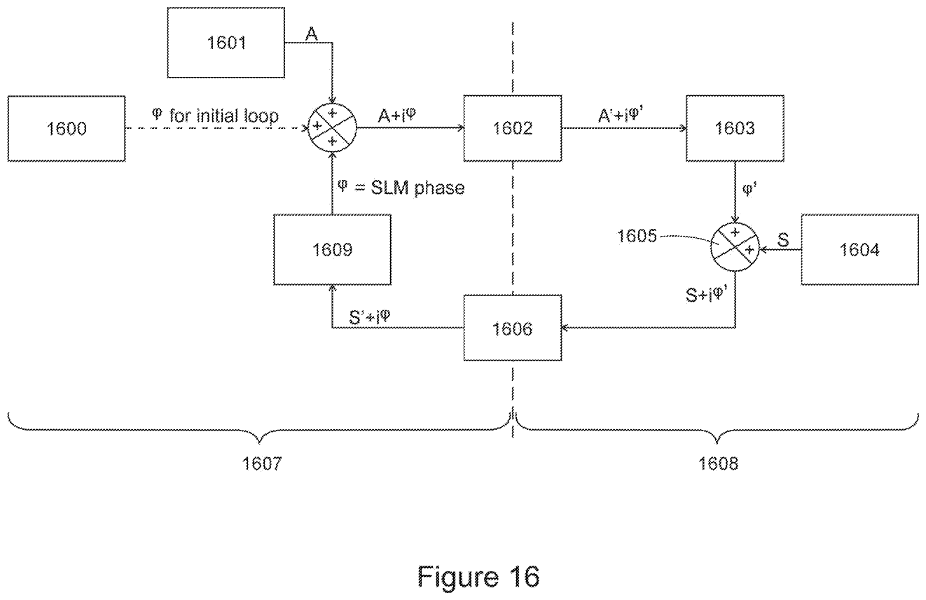

For a given split beam distribution to be obtained by means of the SLM, we compute the phase to be displayed with an iterative phase retrieval Fourier algorithm such as the Gerchberg-Saxton algorithm. FIG. 16 contains a flowchart illustrating an algorithm for computing the phase of the SLM device according to an example embodiment.

In the algorithm of FIG. 16, we start with a random phase φ referenced by 1600 and a constant amplitude 1601 which corresponds an amplitude A of the laser used. We make the Fourier transform 1602 of the complex image A+iφ (i is the imaginary unit symbol) composed of the random phase φ and constant amplitude A. The result of this Fourier transform 1602 is effectively the reconstruction plane 1608. We calculate the phase φ′ of the resulting image 1603 representing the reconstruction plane and add 1605 a desired split beam distribution S 1604 as the amplitude of the new complex image. We then take this complex image S+iφ′ and do an inverse Fourier transform 1606 to obtain a new complex image S′+iφ to go back to the SLM screen 1607. We then extract 1609 the phase φ from this new complex image, which is the phase that needs to be sent to the SLM to display the desired split beam distribution (not illustrated).

The reconstruction efficiency may be improved by running this algorithm as a loop several times, e.g., between 1 and 100 times.

After the SLM we place a reconstruction lens in order to make the Fourier transform on the phase of the light and obtain the desired split beam distribution in the Fourier plane of the lens. This is illustrated for example in FIG. 2 by the feature having the reference 216.

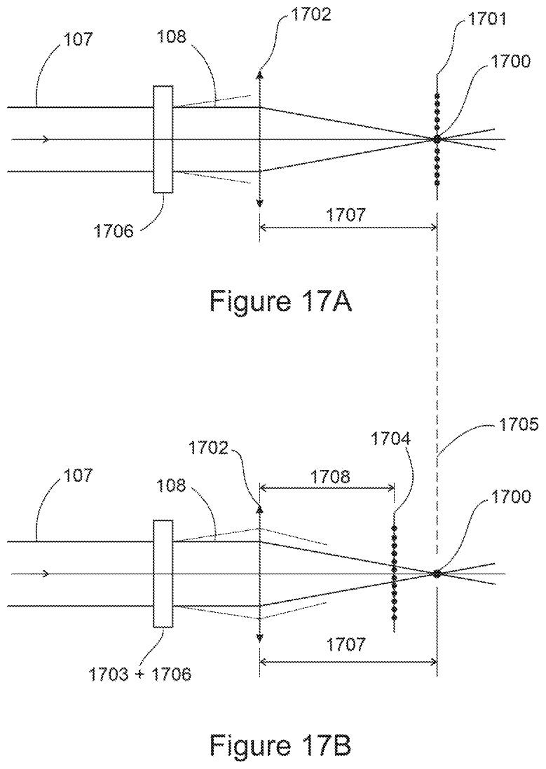

FIGS. 17A and 17B show two illustrations of a laser primary beam 107 and a reconstruction plane 1701, 1704, whereby the reconstruction plane 1701 is distant by a reconstruction length 1707 from the SLM 1706, FIG. 17A showing a configuration in which a zeroth order 1700 contributes principally to an over-powering in the engraving (engraving not illustrated), and FIG. 17B showing a shifted position of the reconstruction plane 1704, where the beams of first order contribute principally to the engraving (engraving not illustrated).

Referring to FIG. 17A, ideally, all energy from the laser primary beam that is affected by the SLM would be rearranged in the desired distribution. Unfortunately, some portion of the energy will be left unaffected because the SLM 1706 has spaces between each pixel (not illustrated in FIG. 17) where light is scattered and not perfectly controlled. This part of light and other parts of light that are not controlled will contribute to the apparition of the zeroth order 1700 in a Fourier plane 1705/reconstruction plane 1701 of the reconstruction lens 1702.

To solve this issue, we may use for example either one of two methods.

The first method (not illustrated) consists in removing as much light as possible that is left unaffected by the SLM display using a polarizing beam splitter. This polarizing beam splitter rejects light with a vertical polarization if the SLM display is configured to work on horizontally polarized light.

The second method illustrated in FIG. 17B consist in adding a Fresnel phase of a Fresnel lens 1703 to the computed phase from the Gerchberg-Saxton algorithm. This Fresnel phase will move a plane 1704 where the split beams are reconstructed away from the Fourier plane 1701 of the reconstruction lens 1702, in the case of FIG. 17B at a new reconstruction length 1708 from the reconstruction lens 1702.

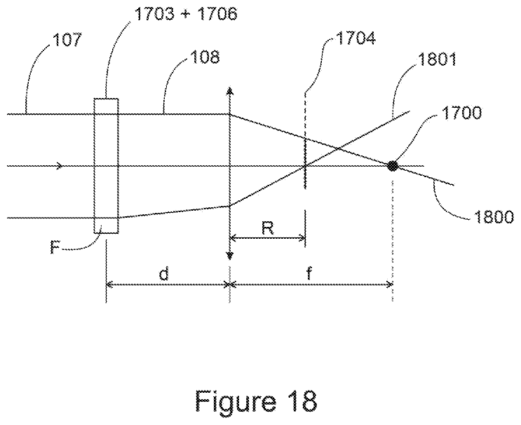

FIG. 18 illustrates a further example of a use of a Fresnel phase with the Fresnel lens 1703 at the SLM 1706 in order to shift the reconstruction plane 1704 in respect to the zeroth order 1700 of created split beams. FIG. 18 further illustrates a beam 1800 contributing to the zeroth order, and a beam 1801 contributing to the split beam distribution.

The new position of the shifted reconstructed plane 1704 can be calculated using the following formula:

$$( new distance from reconstruction lens ) = ( reconstruction lens focal length ) \times ( ( Fresnel focal length ) - 1 ) / \\ ( reconstruction lens focal length + Fresnel focal length - distance between SLM and reconstruction lens )$$

$$R = f ( F - d ) / ( f + F - d )$$

### Power Controlling Device

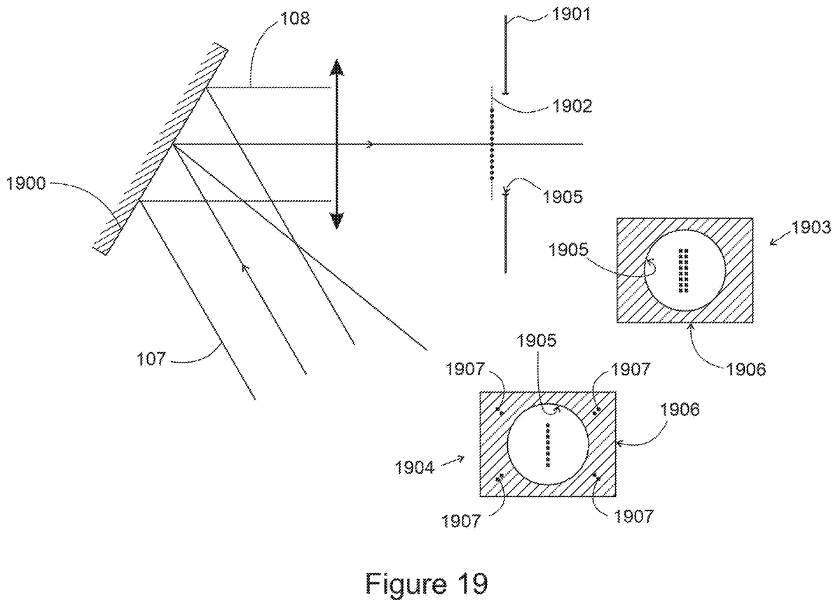

FIG. 19 illustrates a power control mechanism comprising a beam masking device according to an example embodiment. This power control mechanism is a preferred embodiment of the power control mechanism 218, 219 illustrated in FIG. 2.

The power control mechanism has a goal of adjusting the power of the split beam distribution so that the engraving is done with similar fluence over all the split beams.

The primary laser beam 107 on a SLM head 1900 has a constant power and the split beam power distribution in the plurality of split beam 108 depends on the number of split beams that are reconstructed. A given number of split beams gives a specific fluence for each split beams. If we desire to change the number of split beams, e.g., to engrave with fewer split beams simultaneously, and the laser power stays the same, the power distribution between the split beams changes and each split beam either has a larger fluence or a lower fluence than the in other distributions.

To solve this issue, we may introduce a masking device 1901. This masking device 1901 is in a position that coincides with the reconstruction plane 1902. The power of the laser (laser not illustrated) may be set using either the internal power or a power regulator such as the power regulator 201 illustrated in FIG. 2 or for example an optical modulator so that the desired fluence per split beam is reached when the largest distribution of split beam is used.

When engraving with a different number of split beams, in order to compensate the power, we keep the same number of split beams in the reconstruction plane 1902 but we shift the position of the undesired split beams into areas that will be blocked by the masking device 1901.

Eventually, as already mentioned herein above, it could also be possible to adjust the power of the split beam distribution by changing the power of the laser or by controlling the optical modulator. But these two options are relatively slow and can introduce some delay in the engraving process.

When using the power control device, the only step that is required is to compute the phase of the split beam distribution by taking into consideration the split beams that need to be masked. When displaying the new phase for the new distribution, the power adjustment is performed on the spot with no additional delay. The references 1903 and 1904 illustrate examples of power control wherein different phases of the beam distribution lead to different beams being masked. Reference 1905 points to a border of the masking device 1905, while reference 1906 indicates a border of the reconstruction plane 1902. In the example 1903 the phase is set by the SLM to have 16 beams distributed over 2 parallel lines in the area of the reconstruction plane delimited by the border of the masking device 1905. In the example 1904 the phase set by the SLM is changed such that merely 8 beams distributed over one straight line are reconstructed in the area of the reconstruction plane delimited by the by the border of the masking device 1905. The remaining 8 beams are reconstructed on the masking device in pairs 1907 thereby reducing the overall power for engraving because the remaining 8 beams are effectively blocked.

### Positioning Device

The positioning device such as for example the positioning device 114 illustrated in FIG. 2, is configured to hold the workpiece and move the workpiece in front of the microscope objective lens or the optical set-up as a whole.

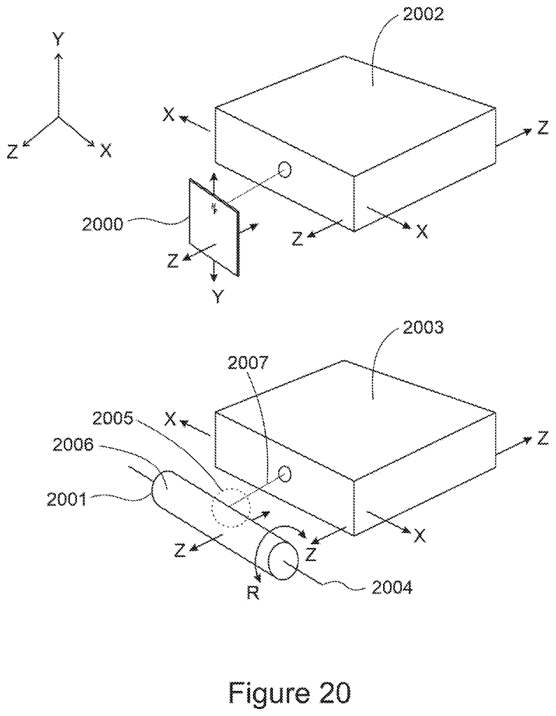

Referring to FIG. 20, two further embodiments of the set-up, the positioning device may be distributed between a plane workpiece 2000 in the upper part of FIG. 20 or a cylindrical workpiece 2001 in the lower part of FIG. 20, and the whole optical setup 2002 and 2003 respectively. For instance, the optical setup 2002 or 2003 would be allowed to translate on a horizontal axis X while the workpiece 2000 may either move along a vertical axis Y when engraving a plate, and the cylindrical workpiece 2001 would be on a rotational axis 2004 to rotate in direction R when engraving a roller.

One or two axes in combination control the distance in Z direction between the focusing head (not illustrated in FIG. 20) and the workpiece by either moving the optical setup 2002, 2003 or the workpiece 2000, 2001 or a combination of both.

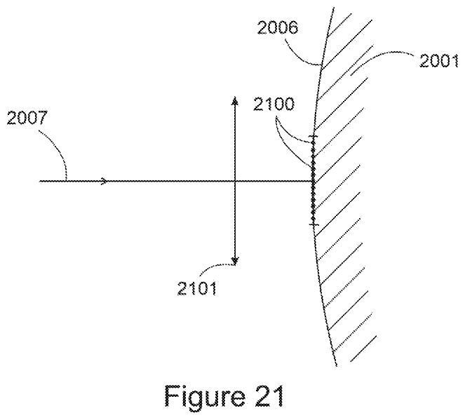

A circle of dashed line 2005 indicates a location on a surface 2006 of the cylindrical workpiece 2001 where a light 2007 from the optical setup 2003, comprises split beams and the autofocus probe beam (split beams and probe beam not illustrated) which impact the surface 2006 in their respective focus. This is explicated in FIG. 21, where the respective foci 2100 of the split beams are illustrated at the surface 2006 of the cylindrical workpiece 2001. The focus of the focused autofocus probe beam is not illustrated in FIG. 21. A microscope objective lens 2101 from the optical setup 2003 (not illustrated in FIG. 21) is configured to focus the split beam 2007 and the autofocus probe beam.

The motion of the axes preferably meets an accuracy with a maximum tracking error of +/−5 μm over 100 mm and repeatability of +/−10 μm over the whole travel distance.

The axes may further be configured to move the surface of the workpiece 2000, 2001 at a speed greater than 10 mm/s, typically below 10 m/s. The engraving speed depends upon the laser frequency, the focusing spot diameter and the desired distance between two laser pulses with the following formula:

$$( distance between two pulses ) = ( surface speed ) / ( laser frequency )$$

### Examples of Preferred Use Cases of the Invention

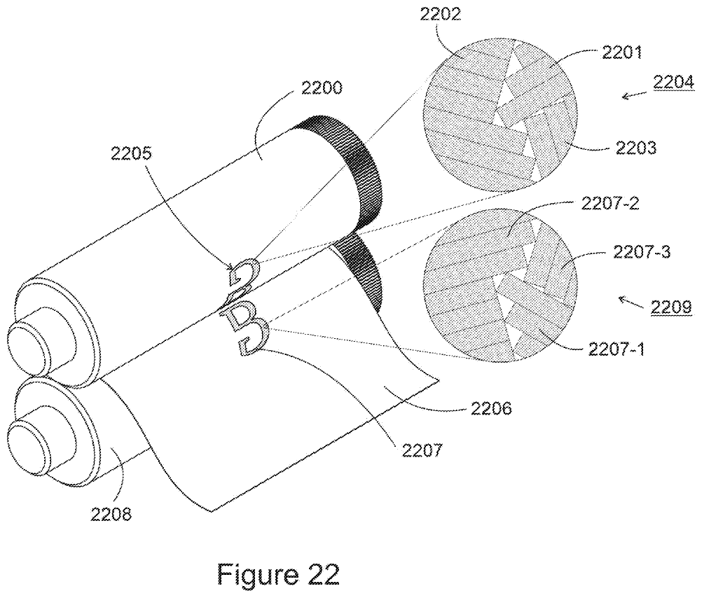

As illustrated for a first example of preferred use case in FIG. 22 a workpiece may be an embossing roller 2200 having an axial cylindrical symmetry, e.g., a steel roller having a diameter between 10 mm and 250 mm and a length between 50 mm and 1500 mm. The embossing roller 2200 may be structured with an engraved pattern 2205 on its lateral surface according to the invention, so that diffraction gratings 2201, 2202, 2203 are engraved on its lateral surface as illustrated in a magnified view 2204 of the engraving 2205. The embossing roller 2200 may be used as an embossing tool in order to engrave products such as a foil 2206 and obtain an embossed pattern 2207, with embossed diffraction gratings or gratings constituting a computer-generated hologram 2207-1, 2207-2, 2207-3 as represented in a magnified view 2209 of the embossing, corresponding to diffraction gratings 2201, 2202, 2203. The embossed diffraction gratings may be used to fulfil purposes of for example aesthetics, design, authentication, brand communication, etc. The so engraved embossing roller 2200 may be mounted in an embossing set-up (not illustrated in FIG. 22), for instance a set-up with two rollers, the engraved embossing roller 2200 and a counter-roller 2208, whereas the latter is slick in the here depicted example.

This preferred use case of the invention is appropriate for the fine embossing of thin films or thin packaging foils having a thickness in an approximate range from 5 μm to 500 μm using the rotational process as illustrated in FIG. 22. It is well known in the food industries, pharmaceuticals, commodity goods, tobacco industry, luxury, and so on, to emboss thin packaging films and foils using rotational embossing rollers. Such thin packaging foils may be intended to be wrapped around a bunch of cigarettes or reduced risk tobacco products, or to be used as packaging material for coffee or tea tabs, for chocolate, butter or similar food products, as well as in pharmaceuticals, fragrances, electronics, jewelry or watches. The embossed thin film or foil may for example be any one of the list comprising a metal foil, a metal foil laminated with organic substrates, a plastic film laminated with organic substrates such as paper, a polymer film laminated with organic substrates such as paper, a metallized polymer film, a polymer film, a hybrid polymer film, or hybrids in general.

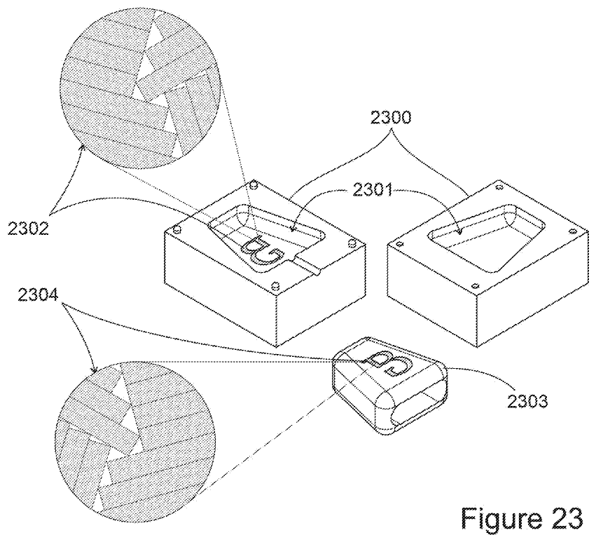

FIG. 23 depicts a second preferred use case example of the invention, in which a workpiece 2300 whose lateral dimensions, i.e., length, width, height, may be smaller than 200 mm, which presents at least a cavity 2301, and which may be used as injection molding die, is structured according to the invention, in order to fulfil aesthetics, design, authentication, brand communication, etc. purposes for objects that will be made using the molding die.

This preferred second use case example of the invention is appropriate for the transfer of the engraved diffraction gratings 2302 into a molten polymer 2303 by injection molding, whereas the molten polymer completely fills the at least one cavity 2301 of the workpiece 2300 and upon cooling solidifies and builds accordingly a plastic part having the shape of the at least one cavity and the transferred diffraction gratings 2304 on its outer surface. The polymer may for example be any one of the lists comprising polycarbonate, polypropylene, polystyrene, PMMA, a hybrid polymer grade or hybrids in general.

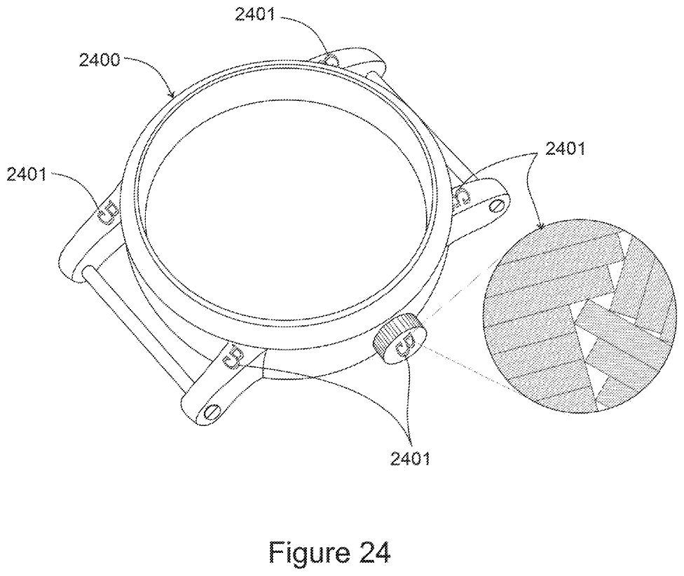

FIG. 24 depicts a third preferred use case example of the invention, in which a workpiece 2400, whose lateral dimensions, i.e., length, width, height, may be smaller than 100 mm, and which may be used as a jewelry part, as a watch component, for example as a wristwatch case.

At least a diffraction grating 2401 may be engraved using a device according to the invention on the outer surface of the workpiece 2400 to fulfill purposes of for example aesthetics, design, authentication, brand communication, etc. The workpiece 2400 is preferably metallic, for example of steel, of a gold alloy, of platinum, or of any noble metal alloy and its outer surface may exhibit a surface roughness that is better than the N2 finishing grade.

According to the invention, an engraved pattern 2401 may consist of diffraction gratings or gratings constituting a computer-generated hologram that are engraved on specific elements of the workpiece 2400.

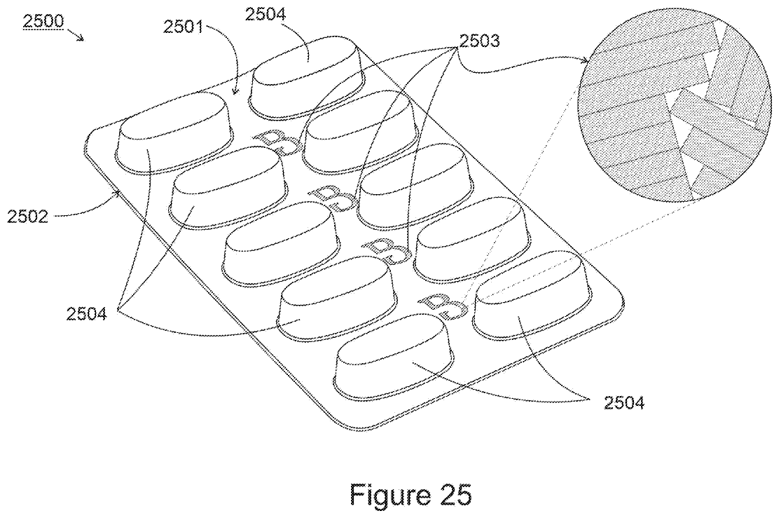

FIG. 25 illustrates a further preferred use case example of the invention, in which diffractive gratings or gratings constituting a computer-generated hologram are engraved onto a roller (not depicted in the figure) and then transferred, in a manner as depicted in FIG. 22, to a component film of a blister package 2500. Blister packages are used in various industries, such as pharmaceuticals, food, tobacco, etc. and consist mainly of a polymer-based film 2501, for instance coated PET with a thickness between 50 μm and 150 μm, and a metallic-based film 2502, for instance aluminum foil with a thickness between 20 μm 50 μm, and that are sealed together, so that pouches 2504 for a product to be packed are constituted. At least one of the polymer-based film 2501 or the metallic-based film 2502 may be embossed using a roller engraved according to the invention, as depicted in FIG. 22, so that the at least one film embeds engraved patterns 2503 containing diffraction gratings or gratings constituting a computer-generated hologram, in order to fulfil aesthetics, design, authentication, brand communication, etc. purposes.

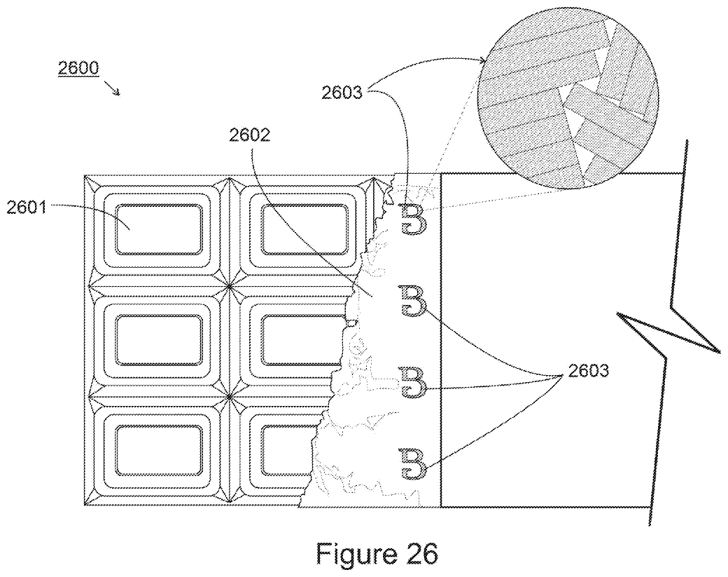

FIG. 26 illustrates a further preferred use case example of the invention, in which diffractive gratings or gratings constituting a computer-generated hologram are engraved onto a roller (not depicted in the figure) and then transferred, as depicted in FIG. 22, to a metallic-based film 2602, for instance an aluminum film with a thickness between 5 μm and 25 μm, belonging to a food package 2600, wrapping and preserving a food product 2601, for instance chocolate.

The metallic-based film 2602 may be embossed using a roller engraved according to the invention, as depicted in FIG. 22, so that it embeds engraved patterns 2603 containing diffraction gratings or gratings constituting a computer-generated hologram, in order to fulfil aesthetics, design, authentication, brand communication, etc. purposes.

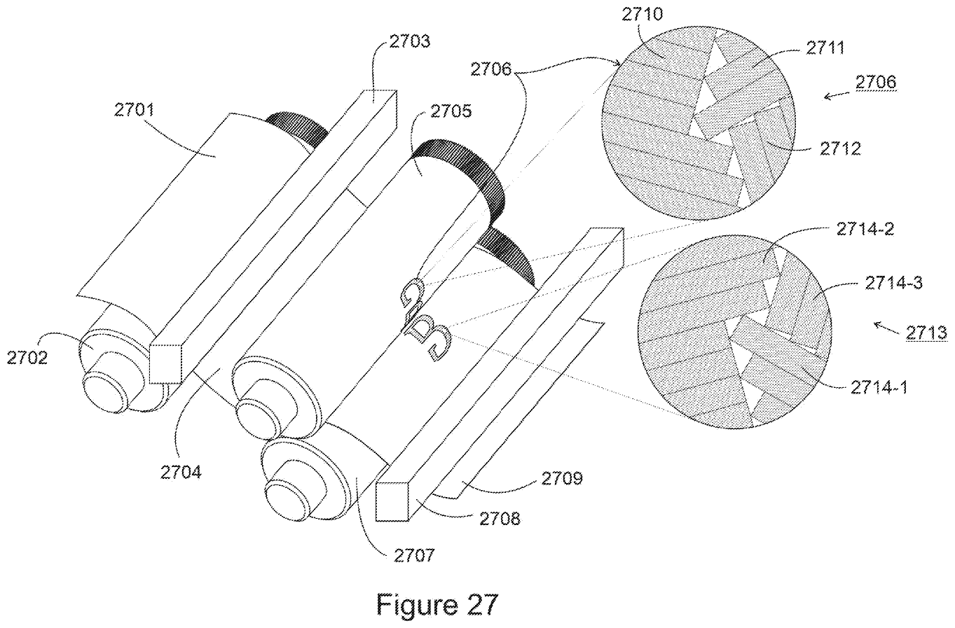

A further example of preferred use case is explained in FIG. 27. On a roller 2705 diffraction gratings or gratings constituting a computer-generated hologram are engraved according to the invention and the roller 2705 is used in connection with a film 2701, which can be any one of the list comprising a metal foil, a metal foil laminated with organic substrates, a plastic film laminated with organic substrates such as paper, a polymer film laminated with organic substrates such as paper, a metallized polymer film, a polymer film, a hybrid polymer film, or hybrids in general. The film 2701 is guided by a guiding roller 2702 in front of a unit 2703, which deposes onto the film 2701 a transparent or semi-transparent organic material, for instance a resin or a lacquer that can be cured using IR- or UV-radiation, and pre-cures it to a film 2704 bearing a pre-cured polymer coating.

The film 2704 is guided between the engraved roller 2705 bearing the engraved pattern 2706 containing diffraction gratings 2710, 2711, 2711 or gratings constituting a computer-generated hologram and a slick roller 2707. The engraved pattern 2706 is embossed into the film 2704, which then passes in front of a final curing station 2708. As a result, a film 2709 consisting of the film 2701 and of a cured transparent or semi-transparent organic material bearing the embossing 2713 of the engraved pattern 2706 containing diffraction gratings 2714-1, 2714-2, 2714-3 or gratings constituting a computer-generated hologram in order to fulfil aesthetics, design, authentication, brand communication, etc. purposes is obtained.

1. A device for engraving a diffraction grating on a workpiece, comprising
an optical set-up comprising a laser, a beam forming device, a beam splitting device, and a focusing head;
the laser configured to output a laser beam;
the beam forming device configured to control a diameter of and a light intensity distribution in the laser beam, and output a primary laser beam;
the beam splitting device configured for a splitting of the primary laser beam into a plurality of split beams for the engraving;
the focusing head comprising
a microscope objective lens configured to focus the respective split beams in respective foci on the workpiece,
an auto-focusing system configured to produce a positioning signal for adjusting and maintaining a distance between the microscope objective lens and the workpiece in order to maintain the respective foci of the split beams on the workpiece and output the positioning signal; and
a micro-actuator configured to receive the positioning signal and adjust the distance between the microscope objective lens and the workpiece, whereby the auto-focusing system and the micro-actuator are operationally connected in a closed-loop;
a positioning device configured to perform a relative positioning between the workpiece in the respective foci of the split beams, and the optical set-up; and
a controller configured to control the positioning device and the laser according to engraving instructions for the diffraction grating.

2. The device for engraving of claim 1, further comprising
a power regulator comprising an optical modulator configured to adjust a power of the laser beam.

3. The device for engraving of claim 1, further comprising
an engraving power control device configured to selectively mask at least one of the plurality of split beams, thereby limiting a total beam power incident on the workpiece to that of non-masked split beams.

4. The device for engraving of claim 1, wherein the beam splitting device comprises a Spatial Light Modulator (SLM).

5. The device for engraving according to claim 1,
wherein
the auto-focusing system comprises
a probe light source emitting a probe light beam, the probe light source being configured as a low coherence light source and the probe light source being further configured to direct the probe light beam to the workpiece through the microscope objective lens;
an interferometry set-up comprising a reference path and a measuring path, configured to receive as the measuring path the probe light beam after reflection on the workpiece, and the reference path being obtained by sending the probe light beam over a determined path comprising a reference lens configured to mimic the microscope objective lens and a mirror configured to mimic the workpiece, further whereby the reference path is of a given fixed predetermined length such that the difference between the reference path's given fixed predetermined length and a measurement path length is smaller than the spatial coherence length of the low coherence light source, further whereby the interferometry set-up is configured to combine a reference light beam exiting from the reference path and a measurement light beam exiting from the measurement path in order for these to interfere and output an interference spectrum;
an optical spectrometer configured to read the interference spectrum output of the interferometry set-up and output an optical spectrum;
a computing unit configured to input the optical spectrum from the optical spectrometer, analyze it and compute positioning data;
a micro-actuator configured to move the microscope objective lens; and
a digital/analog converter receiving the positioning data and outputting a driving signal to the micro-actuator in order to maintain the workpiece in the respective foci of the split beams.

6. The device for engraving according to claim 1,
wherein
the auto-focusing system comprises
a probe light source emitting a probe light beam, the probe light source being configured as a low coherence light source and the probe light being further configured to direct the probe light beam to the workpiece through the microscope objective lens;
an interferometry set-up comprising a reference path and a measuring path, configured to receive as the measuring path the probe light beam after reflection on the workpiece, and the reference path being obtained by sending the probe light beam over a determined path comprising a reference lens configured to mimic the microscope objective lens and a mirror configured to mimic the workpiece, further whereby the reference path is of a given fixed predetermined length such that the difference between the reference path's given fixed predetermined length and a measurement path length is smaller than the spatial coherence length of the low coherence light source, further whereby the interferometry set-up is configured to combine a reference light beam exiting from the reference path and a measurement light beam exiting from the measurement path in order for these to interfere and output an interference spectrum;
an optical spectrometer configured to read the interference spectrum output of the interferometry set-up and output an optical spectrum;
a computing unit configured to input the optical spectrum from the optical spectrometer, analyze it and compute positioning data;
a micro-actuator configured to move the positioning device; and
a digital/analog converter receiving the positioning data and outputting a driving signal to the micro-actuator in order to maintain the workpiece in the respective foci of the split beams.

7. A method for engraving a diffraction grating on a workpiece,
comprising
providing a laser beam;
forming the laser beam by controlling a diameter and a light intensity distribution in the laser beam, and output a primary laser beam;
splitting the primary laser beam into a plurality of split beams for engraving;
focusing the respective split beams on the workpiece with a microscope objective lens;
auto-focusing the respective split beams by producing a positioning signal for adjusting and maintaining a distance between the microscope objective lens and the workpiece in order to maintain the respective foci of the split beams on the workpiece, outputting the positioning signal;
receiving the positioning signal at the input of a micro-actuator and performing with the micro-actuator an adjustment of the distance between the microscope objective lens and the workpiece, whereby the autofocusing and the adjustment of the distance are performed in a closed-loop;
performing a relative positioning between the workpiece in the respective foci of the split beams, and the optical setup by means of a positioning device, and controlling the positioning device and the laser according to engraving instructions for the diffraction grating and engraving the diffraction grating on the workpiece.

8. The method for engraving of claim 7, further comprising a step of
adjusting a power of the laser beam by means of a power regulator that comprises an optical modulator.

9. The method for engraving of claim 7, further comprising a step of
controlling an engraving power by selectively masking at least one of the plurality of split beams, thereby limiting a total beam power incident on the workpiece to that of non-masked split beams.

10. The method for engraving of claim 7, wherein
the splitting of the primary laser beam into a plurality of split beams for engraving comprised employing a Spatial Light Modulator (SLM).

11. The method for engraving according to claim 7, wherein
the step of auto-focusing comprises
emitting a probe light beam with a probe light source, the probe light source being configured as a low coherence light source, the emitting comprising a directing of the probe light beam to the workpiece through the microscope objective lens;
implementing an interferometry set-up with a reference path and a measuring path, whereby the probe light beam is directed in the measuring path to pass through the microscope objective lens and to reflect on the workpiece, and the probe beam is further split and directed in the reference path by sending the probe light beam over a determined path that comprises a reference lens configured to mimic the microscope objective lens and a mirror configured to mimic the workpiece, further whereby the difference between the reference path length and a measurement path length is smaller than the spatial coherence length of the low coherence light source, further whereby the interferometry set-up is configured to combine a reference light beam exiting from the reference path and a measurement light beam exiting from the measurement path in order for these to interfere and output an interference spectrum;
reading the interference spectrum output of the interferometry set-up by means of an optical spectrometer and outputting an optical spectrum;
inputting the optical spectrum from the optical spectrometer in a computing unit and analyzing it and compute positioning data;
moving the microscope objective lens by means of a micro-actuator; and
receiving the positioning data in a digital/analog converter and outputting a driving signal to the micro-actuator in order to maintain the workpiece in the respective foci of the split beams.

12. The method for engraving according to claim 7, wherein
the step of auto-focusing comprises
emitting a probe light beam with a probe light source, the probe light source being configured as a low coherence light source, the emitting comprising a directing of the probe light beam to the workpiece through the microscope objective lens;
implementing an interferometry set-up with a reference path and a measuring path, whereby the probe light beam is directed in the measuring path to pass through the microscope objective lens and to reflect on the workpiece, and the probe beam is further split and directed in the reference path by sending the probe light beam over a determined path that comprises a reference lens configured to mimic the microscope objective lens and a mirror configured to mimic the workpiece, further whereby the difference between the reference path length and a measurement path length is smaller than the spatial coherence length of the low coherence light source, further whereby the interferometry set-up is configured to combine a reference light beam exiting from the reference path and a measurement light beam exiting from the measurement path in order for these to interfere and output an interference spectrum;
reading the interference spectrum output of the interferometry set-up by means of an optical spectrometer and outputting an optical spectrum;
inputting the optical spectrum from the optical spectrometer in a computing unit and analyzing it and compute positioning data;
moving the positioning device by means of a micro-actuator; and
receiving the positioning data in a digital/analog converter and outputting a driving signal to the micro-actuator in order to maintain the workpiece in the respective foci of the split beams.
